(19) United States
(12) Patent Application Publication
(10) Pub. No.: US 2021/0195696 A1
(43) Pub. Date: Jun. 24, 2021

(54) METHOD AND DEVICE FOR EMITTING RADIATION OR HEAT FROM A SURFACE

(71) Applicant: SABIC GLOBAL TECHNOLOGIES B.V., Bergen op Zoom (NL)

(72) Inventor: Steven Marc Gasworth, Wixom, MI (US)

(21) Appl. No.: 16/757,922

(22) PCT Filed: Feb. 28, 2019
(86) PCT No.: PCT/US2019/019955

§ 371 Date: Apr. 21, 2020

(30) Foreign Application Priority Data
Feb. 28, 2018 (EP) 18159329.4

(51) Int. Cl. H05B 3/84

(52) U.S. Cl. CPC H05B 3/84; H05B 2203/032

(57) ABSTRACT

In an aspect, an emitting device can comprise a radiation source that emits a source radiation coupled to an edge of an emitting layer; wherein the emitting layer comprises an emitting region comprising a host material and an emitting agent and a non-emitting region comprising the host material and that is free of the emitting agent; wherein the emitting agent comprises at least one of a luminescent agent or an absorber; wherein the emitting layer has a first surface and a second surface; wherein, during use, the source radiation is transmitted from the radiation source through the edge and excites the emitting agent such that, if the luminescent agent is present, the luminescent agent emits an emitted radiation, wherein at least a portion of the emitted radiation exits through the first surface through an escape cone; and, if the absorber is present, the absorber emits heat.

### CROSS-REFERENCE TO RELATED APPLICATION

This application claims the benefit of European Application Serial No. EP18159329.4 filed Feb. 28, 2018. The related application is incorporated herein in its entirety by reference.

### BACKGROUND

Heating devices have been developed for applications such as defrosting, defogging, and/or deicing a surface. These devices suffer from one or more of an obstructed view through the device, opacity, optical distortion, insufficiently uniform heating, insufficient heating far from the edge of the device, inability to localize the heating area, and low efficiency. A device that is able to overcome one or more of these drawbacks is desirable.

### BRIEF DESCRIPTION

Disclosed herein is a device and method for emitting one or both of radiation or heat from a surface.

In an aspect, an emitting device can comprise a radiation source that emits a source radiation coupled to an edge of an emitting layer; wherein the emitting layer comprises an emitting region comprising a host material and an emitting agent and a non-emitting region comprising the host material and that is free of the emitting agent; wherein the emitting agent comprises at least one of a luminescent agent or an absorber; wherein the emitting layer has a first surface and a second surface; wherein the edge has a height of d and the first surface has a length L, wherein length L is greater than height d, and the ratio of the length L to the height d is greater than or equal to 10; wherein, during use, the source radiation is transmitted from the radiation source through the edge and excites the emitting agent such that, if the luminescent agent is present, the luminescent agent emits an emitted radiation, wherein at least a portion of the emitted radiation exits through the first surface through an escape cone; and, if the absorber is present, the absorber emits heat.

In an aspect, a method of forming the emitting layer comprises injection molding a host material composition comprising the host material into a mold to form the non-emitting region; after a first amount of time, injection molding an emitting agent composition while simultaneously injection molding the host material composition into the mold for a second amount of time to form the emitting region; and after the second amount of time, ceasing the injection molding of the host material composition.

In another aspect, a method of forming the emitting layer comprises selectively infusing the emitting agent into a surface of a substrate comprising the host material to form the emitting region that is localized to the first surface.

In an aspect, a method of reducing an amount of water from a surface comprises emitting one or both of radiation and heat from a surface of a device.

In an aspect, the emitting device is a glazing, a lens, a mirror, an exterior panel, a bumper, or a headlamp.

The above described and other features are exemplified by the following figures, detailed description, and claims.

### BRIEF DESCRIPTION OF THE DRAWINGS

The figures are exemplary aspect, wherein the like elements are numbered alike.

FIG. 1 is an illustration of an aspect of a cross-sectional side view of a device comprising an emitting layer;

FIG. 2 is an illustration of an aspect of a cross-sectional side view of an emitting layer having a surface localized emitting region proximal to a first surface;

FIG. 3 is an illustration of an aspect of a cross-sectional side view of an emitting layer having surface localized emitting regions proximal to a first surface and a second surface;

FIG. 4 is an illustration of an aspect of a cross-sectional side view of a device comprising a sensor;

FIG. 5 is an illustration of an aspect of a top-down view of an emitting layer; and

FIG. 6 is a graphical representation of an embodiment of excitation and emission spectra for a luminescent agent, a source spectrum, and an absorber spectrum.

### DETAILED DESCRIPTION

Heating devices, for example, window defrosters in automobiles, have been developed such that parallel, electrically conductive traces, or electrically conductive coatings, span the length of the window to be defrosted. These traces or coatings can lead to uneven defrosting, can reduce visibility through the window, and can be difficult to apply to complex shapes.

In order to overcome at least some of these drawbacks, a device has been developed that comprises a radiation source coupled to an edge of an emitting layer. The emitting layer comprises a host material and an emitting agent, and the emitting layer comprises an emitting region comprising the emitting agent and a non-emitting region that is free of the emitting agent. The emitting agent can comprise one or both of a luminescent agent or an absorber and either or both of an excitation spectrum of the luminescent agent or an absorber spectrum of the absorber can overlap with a source spectrum of the radiation source. If both the luminescent agent and the absorber are present, then the absorber can have an absorption spectrum that overlaps with an emission spectrum of the luminescent agent. The device can have the advantage of the emitting agent being localized to a specified area on the surface of the device.

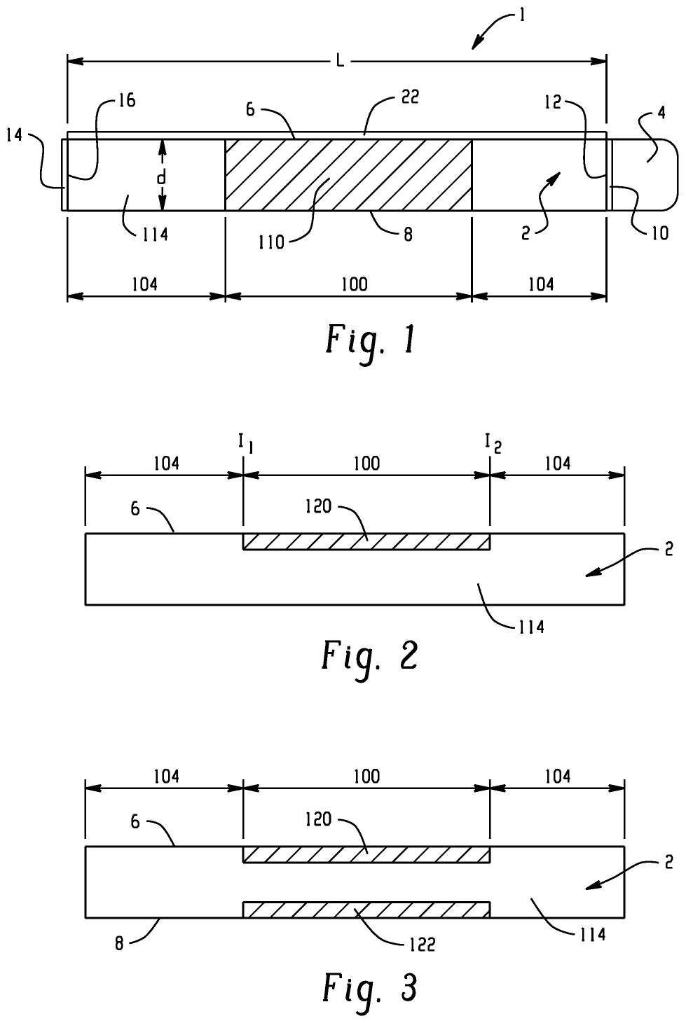

In the device, light (including infrared light) from the radiation source propagates by total internal reflection (TIR) in the non-emitting region to the emitting region. When the emitting agent comprises a luminescent agent, photons that encounter the luminescent agent can be absorbed and re-emitted from the luminescent agent into a so-called escape cone to be emitted from a broad surface of the device. That is, the luminescent agent can serve in part to deflect light from TIR, a state of confinement within the device, to a broad surface, from which the light can escape and be absorbed by water (for example, liquid water or ice) on the surface of the device thereby heating the water. Because this deflection results from light interaction with the luminescent agent, it occurs primarily in the emitting region where the luminescent agent is concentrated. When the emitting agent comprises an absorber, photons that encounter the absorber can be absorbed and the absorber can emit heat. The emitting device can heat the surface by heating the emitting layer and conducting heat to the surface, thereby heating the surface, or it can heat the surface by radiation. In either case of the luminescent agent or the absorber, power from the edge-coupled source is thereby projected to the emitting region, enabling at least one of defrosting, deicing, or defogging in that region. As used herein, the term “heat” is being used to describe the emission from the absorber and the term “radiation” is used to describe the emission from the luminescent agent. While is it understood that heat is a form of radiation, these terms are being used in order distinguish the two different emissions and to facilitate the understanding of the respective emitting agents. Also, as used herein, the term “broad surface” is used to refer to a surface of the emitting layer having a length, L, and a width not shown in the cross-sectional image of FIG. 1, where the broad surface is not defined by a length of the illustrated height, d.

The device is able to achieve one or more of the following: 1) uniform emission in the emitting region; 2) a preheated surface to pre-empt the formation of fog, frost, and/or ice in the emitting region; 3) one or both of the radiation or the heat can be emitted from both of the broad surfaces in the emitting region; or 4) a uniform heating in the emitting region. The device can reduce an amount of water (for example, liquid water or ice) on at least one of the broad surfaces of the emitting layer in the emitting region. The device can melt a 1 millimeter thick layer of ice located on at least one of the broad surfaces in the emitting region in less than or equal to 15 minutes, or less than or equal to 5 minutes, or 0.5 to 4 minutes. As used herein, uniform emission refers to the measured emission at all locations in the emitting region being within 40%, or 30%, or 20% of the average emission being emitted from the emitting region. As used herein, uniform heating refers to the measured surface temperature at all locations in the emitting region being within 40%, of 30%, or 20% of the average surface temperature in the emitting region.

It is noted that, although luminescent agents have been used in luminescent solar concentrators (LSC), for example, in solar panels that function to absorb light from the sun, as is discussed in U.S. Patent Applications 2017/0357042 and 2017/0311385, they function in a completely different manner as compared with their use in the present emitting device.

The device can comprise an emitting layer that comprises a host material and at least one emitting agent. The emitting layer can be flat, for example, if the device will be used as a mirror, or curved, for example, if the device will be used as a lens or a window. The emitting layer can have two broad, coextensive surfaces, a first surface and a second surface, with a length L that are bounded by short edges with a height d, as illustrated in FIG. 1. The ratio of L to d can be greater than or equal to 10, or greater than or equal to 30, or 30 to 10,000, or 30 to 500. The distance between the first surface and the second surface of the emitting layer can be constant or can vary at different locations in the device.

Referring now to the figures, FIG. 1 illustrates a cross-sectional view of emitting device 1 comprising emitting layer 2 and radiation source 4. Emitting layer 2 has two broad, coextensive outer surfaces of length L that are bounded by short edges with height d. Radiation source 4 is an edge coupled radiation source that emits radiation to an edge of emitting layer 2. While it is illustrated that the device comprises one edge coupled radiation source, it is understood that the device can comprise one or more edge coupled radiation sources located on one or more edges of the emitting layer. Emitting layer 2 comprises height spanning emitting region 110 comprising at least one emitting agent. One or both of radiation or heat is emitted from the emitting agent through first surface 6 and second surface 8 in emitting area 100. Emitting layer 2 also comprises non-emitting region 114 that is free of an emitting agent. Neither radiation nor heat is emitted from the emitting agent through first surface 6 and second surface 8 in area 104. It is noted that radiation or heat can be emitted in the non-emitting region from agents other than the emitting agent (such as a colorant) or from the host material itself if it can absorb radiation from the radiation source. In this case, the non-emitting region is defined as a region that emits less of one or both of radiation or heat than that emitted in the emitting region.

Optional layer 22 can be located on first surface 6. Optional layer 22 can comprise a protective layer, for example, at least one of an ultraviolent protective layer or an abrasion resistant layer. Optional selectively reflecting mirror 10 can be located on source edge 12 in between radiation source 4 and emitting layer 2 and optional edge mirror 14 can be located on edge 16. Edge mirror 14 and selectively reflecting mirror 10 can reduce the amount of radiation loss through the edges.

FIG. 2 and FIG. 3 illustrate that emitting layer 2 can comprise surface localized emitting region 120. FIG. 2 illustrates that surface localized emitting region 120 can be localized to first surface 6. One or both of radiation or heat is emitted from the emitting agent at least through first surface 6 in emitting area 100. FIG. 2 further illustrates that non-emitting region 114 spans the length of the emitting area 100 in the region that is remote from first surface 6 and proximal to second surface 8. A thickness of the surface localized emitting region 120 can be 10 to 1,000 micrometers, or 50 to 500 micrometers, or 100 to 200 micrometers. The thickness of the surface localized emitting region can span less than or equal to 90%, than or equal to 50%, or 0.01 to 25%, 0.1 to 50%, or 0.1 to 10% of the height of the emitting layer.

FIG. 3 illustrates that surface localized emitting region 120 can be localized to first surface 6 and surface localized emitting region 122 can be localized to second surface 8. One or both of radiation or heat is emitted from the emitting agent through first surface 6 and second surface 8 in emitting area 100. FIG. 3 further illustrates that non-emitting region 114 spans the length of the emitting area 100 in a center region located between first surface 6 and second surface 8. It is noted that while surface localized emitting region 120 and surface localized emitting region 122 are illustrated as both being located in emitting area 100, these regions can define various emitting areas on their respective surfaces that may or may not overlap.

Using a surface localized emitting region, for example, as illustrated in FIG. 2 and FIG. 3 can have several advantages as compared to an embodiment where the emitting agent spans the height d of the emitting layer. For example, a reduced amount of emitting agent can be needed to realize the desired effect, which can reduce overall costs or can result in a decreased occurrence of haze in the emitting region. Additionally, methods of forming the emitting region can be easier and more controllable as the emitting agent can be localized to specific regions with ease and precision. Furthermore, and as are illustrated below, methods of forming a surface localized the emitting agent can occur after the formation of the substrate, which can ensure that the emitting agent is not exposed to the high production temperatures of the substrate. For example, if the host polymer comprises a polycarbonate, compounding temperatures of more than 300° C. can be used when forming the substrate, which could potentially damage the emitting agent. In contrast, typical infusion temperatures can be less than or equal to 100° C., substantially reducing the risk of damage to the emitting agent.

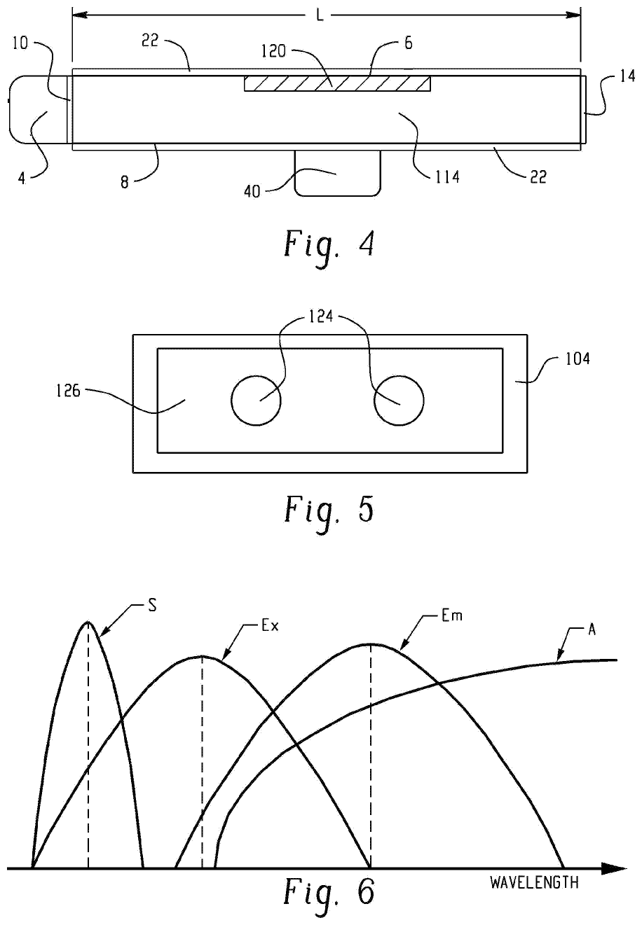

FIG. 4 illustrates that the device can comprise sensor 40 located on a surface of the device. Sensor 40 can be located opposite of surface localized emitting region 120. In this manner, surface localized emitting region 120 can prevent or reduce the presence of water on the surface in the emitting region such that sensor 40 can have a clear view through device. The sensor can be a light detection and ranging (LIDAR) sensor. For LIDAR applications, the emitting agent can comprise a luminescent agent that does not absorb or emit in the 900 to 910 nanometer (nm) range of the spectrum. When the sensor is a next generation LIDAR, the luminescent agent can be one that does absorb or emit in a range of 1,500 to 1,600 nm and the emitting agent can be free of an absorber.

FIG. 5 is an embodiment of a top-down view of an emitting layer comprising non-emitting area 104 and three distinct surface localized emitting regions: two heated areas 124 located in radiation area 126. Heated areas 124 can comprise both an absorber and a luminescent agent and radiation area 126 can comprise the same or different luminescent agent as that in the heated regions. It is noted that the emitting layer can comprise more or fewer surface localized emitting regions and that these regions can be shaped as desired. It is also noted that heating areas 124 do not need to be located in radiation area 126, but could be located in a separate area.

The surfaces of the emitting layer can be smooth surfaces such that they support light guiding by total internal reflection. Likewise, one or both surfaces can be textured, for example, for beam diffusion in lighting applications, where the texturing can act selectively on visible wavelengths while sustaining total internal reflection for longer wavelengths through the device. The surfaces of the emitting layer in the emitting region can be smooth and the surfaces of the emitting layer in the non-emitting region can be textured. The surfaces of the emitting layer in the emitting region can be textured and the surfaces of the emitting layer in the non-emitting region can be smooth.

The emitting region can have a low haze of less than or equal to 5% or less than or equal to 2%. The emitting layer (including the emitting region and/or the non-emitting region) can be transparent such that the material has a visible light transmittance of greater than or equal to 70%, or 70 to 80%. The emitting layer can have a transmittance of 1 to 75%, or 5 to 30% (for example, if the if the emitting layer has a privacy tint), or 60 to 75% (for example, if the if the emitting layer has a solar tint). Transparency to visible light and haze can be determined by using 3.2 mm thick samples using ASTM D1003-11, Procedure B using CIE standard illuminant C, with unidirectional viewing. The emitting layer can be transparent such that the material has a transmittance greater than or equal to 80% in the range of 900 to 910 nm, or 1,500 to 1,600 nm, where transparency in these ranges can be determined using 3.2 mm thick samples using a spectrophotometer.

The host material can comprise a material such as at least one of a polycarbonate (such as a bisphenol A polycarbonate), a polyester (such as poly(ethylene terephthalate) or poly(butyl terephthalate)), a polyarylate, a phenoxy resin, a polyamide, a polysiloxane (such as poly(dimethyl siloxane)), a polyacrylic (such as a polyalkylmethacylate (e.g., poly(methyl methacrylate)) or polymethacrylate), a polyimide, a vinyl polymer, an ethylene-vinyl acetate copolymer, a vinyl chloride-vinyl acetate copolymer, or a polyurethane. The host material can comprise at least one of poly(vinyl chloride), polyethylene, polypropylene, poly(vinyl alcohol), poly(vinyl acrylate), poly(vinyl methacrylate), poly(vinylidene chloride), polyacrylonitrile, polybutadiene, polystyrene, poly(vinyl butyral), or poly(vinyl formal). The host material can at least one of comprise poly(vinyl butyral), polyimide, polypropylene, or polycarbonate. When the emitting layer comprises polycarbonate, the polycarbonate can comprise an IR absorbing polycarbonate. The host material can comprise one or more of the foregoing polymers. The host material can comprise a copolymer comprising one or more of the foregoing polymers.

The emitting agent can comprise a luminescent agent, where the luminescent agent can comprise greater than or equal to 1 luminescent agent. The luminescent agent can comprise greater than or equal to 2 luminescent agents. The luminescent agent can comprise 2 to 6 luminescent agents. The luminescent agent can comprise 2 to 4 luminescent agents. The luminescent agent can comprise a single luminescent agent.

FIG. 6 shows the excitation and emission spectrum of an emitting layer comprising a luminescent agent LA and an absorber A. LA is a downshifting luminescent agent, where emission spectrum Em is shifted to longer wavelengths, where absorbed photons are re-emitted as lower energy photons. It is understood that while FIG. 6 illustrates a downshifting luminescent agent, the emitting layer can comprise an upshifting luminescent agent, where the emission spectrum is shifted to shorter wavelengths. It is further understood that upshifting encompasses up-conversion, whereby absorption of two photons at lower energy yields emission of one photon at higher energy. Source spectrum S overlaps with excitation spectrum Ex of the luminescent agent LA. This overlap results in the production of a first generation of photons with wavelengths represented by emission spectrum Em of the luminescent agent LA that occurs over the length of the emitting area. A portion of those photons, for example, 20 to 30% can be emitted into an escape cone and can exit the emitting layer through at least one of the first surface or the second surface. The remaining photons that were not emitted within an escape cone can be guided by total internal reflection within the emitting layer, where those reaching an edge can be reflected back into the emitting layer, for example, by an edge mirror. These remaining photons can then encounter the same or different luminescent agent or an absorber if present. As the emission spectrum Em overlaps with excitation spectrum Ex the luminescent agent can be excited producing a second generation of photons with wavelengths as represented by emission spectrum Em. This second generation of emitted photons further contributes to photon emission from a surface of the emitting layer through an escape cone, with the balance of the photons being recycled as with the first generation. Accordingly, further generations of photons are likewise produced.

It is understood that in FIG. 6 that while the peaks are illustrated to be slightly offset from each other, they can be further offset from each other or can coincide with each other. It is likewise understood, that while not illustrated, the source, excitation and emission spectra can have tails that extend further along the x-axis below the illustrated base line.

The emitted radiation with an emission spectrum Em can exit the emitting layer or can be absorbed by an absorber, if present, as the emission spectrum Em can overlap with the absorption spectrum A of the absorber. It is noted that when the emitting layer is free of the luminescent agent, then the source spectrum can overlap with the absorption spectrum A of the absorber. In either case, the absorber can absorb either the emitted radiation from the luminescent agent and/or from the source and can produce heat to heat the device.

One skilled in the art can readily envision a source spectrum based on the desired application. For example, the source can be chosen based on a desire to avoid one or both of long wavelength host absorption bands or visible bands.

The luminescent agent can act, not only to shift the photon wavelength, but also to redirect photons. For example, a portion of the first generation photons can be redirected from total internal reflection within the emitting layer into an escape cone so that they can exit the emitting layer and a portion of the first generation photons can excite a further luminescent agent (such as one or both of the first luminescent agent and/or, if present, a further luminescent agent different from the first luminescent agent) or an absorber within the emitting layer.

The size of the luminescent agent can be chosen such that it does not reduce the transparency of the emitting layer, for example, the luminescent agent can be one that does not scatter visible light, for example, light with a wavelength of 380 to 780 nm, or 390 to 700 nm. The luminescent agent can have a longest average dimension of less than or equal to 300 nm, or less than or equal to 100 nm, or less than or equal to 40 nm, or less than or equal to 35 nm. The luminescent agent can be one that does not scatter near infrared light, for example, light with a wavelength of 700 to 2,500 nm, or 700 to 1,600 nm.

The luminescent agent can comprise at least one of a downshifting agent (such as (py)₂₄Nd₂₈F₆₈(SePh)₁₆, where py is pyridine) or an upshifting agent (such as NaCl:Ti²⁺; MgCl₂:Ti²⁺; Cs₂ZrBr₆:Os⁴⁺; or Cs₂ZrCl₆:Re⁴⁺). The upshifting agent can comprise less than or equal to 5 weight percent (wt %), or greater than 0 to 5 wt % of the Ti, Os, or Re based on the total weight of the agent. The luminescent agent can comprise at least one of an organic dye (such as rhodamine 6G), an indacene dye (such as a polyazaindacene dye), a quantum dot, a rare earth complex, or a transition metal ion. The luminescent agent can comprise a pyrrolopyrrole cyanine (PPCy) dye. The organic dye molecules can be attached to a polymer backbone or can be dispersed in the emitting layer. The luminescent agent can comprise at least one of a pyrazine type compound having a substituted amino and/or cyano group, a pteridine compound such as a benzopteridine derivative, a perylene type compound (such as LUMOGEN™ 083 (commercially available from BASF, NC)), an anthraquinone type compound, a thioindigo type compound, a naphthalene type compound, or a xanthene type compound. The luminescent agent can comprise at least one of pyrrolopyrrole cyanine (PPCy), a bis(PPCy) dye, or an acceptor-substituted squaraine. The pyrrolopyrrole cyanine can comprise at least one of BF₂-PPCy, BPh₂-PPCy, bis(BF₂-PPCy), or bis(BPh₂-PPCy). The luminescent agent can comprise a lanthanide-based compound such as a lanthanide chelate. The luminescent agent can comprise a chalcogenide-bound lanthanide. The luminescent agent can comprise a transition metal ion such as at least one of NaCl:Ti²⁺ or MgCl₂:Ti²⁺. The luminescent agent can comprise at least one of YAlO₃:Cr³⁺,Yb³⁺ or Y₃Ga₅O₁₂:Cr³⁺,Yb³⁺. The luminescent agent can comprise at least one of Cs₂ZrBr₆:Os⁴⁺ or Cs₂ZrCl₆:Re⁴⁺. The luminescent agent can comprise a combination comprising at least one of the foregoing luminescent agents.

The luminescent agent can have a molar extinction of greater than or equal to 100,000 inverse molar concentration times inverse centimeters (M⁻¹cm⁻¹). The luminescent agent can have a molar extinction of greater than or equal to 500,000 M⁻¹ cm⁻¹.

The luminescent agent can be encapsulated in a surrounding sphere, such as a silica or polystyrene sphere, and the like. The luminescent agent can be free of one or more of lead, cadmium, or mercury. The luminescent agent can have a quantum yield (also referred to as quantum efficiency) of 0.1 to 0.95. The luminescent agent can have a quantum yield of 0.2 to 0.75.

The luminescent agent can absorb radiation over a first range of wavelengths and can emit radiation over a second range of wavelengths that can partially overlap with the first range. The radiation that can be absorbed by the luminescent agent can originate from the radiation source and/or from the same species of luminescent agent and/or from a different species of luminescent agent.

Emission from the luminescent agent can be directionally isotropic, where emitted photons either exit the device through an escape cone or are confined to the emitting layer by total internal reflection. The direction of the radiation exiting through the escape cone can be uniformly distributed over a wide angular range centered on the direction perpendicular to the broad surfaces of the device.

The emitting agent can comprise an absorber, for example, a radiationless absorber that does not emit radiation in the UV, visible, or infrared spectrum. The absorber can comprise any absorber with an absorption spectrum that overlaps with an emission spectrum of a luminescent agent or the source spectrum. The absorber can be an absorber that does not scatter visible light. The absorber can be a compound that absorbs in the wavelength range of 700 to 2,500 nm, or 700 to 1,500 nm. The absorber can comprise at least one of an organic absorber (such as phthalocynanine compounds or naphthalocyanines compounds) or an inorganic absorber (such as an indium tin oxide (ITO) or an antimony tin oxide (ATO)). The absorber can comprise at least one of a rare earth element (such as Sc, Y, La, Ce, Pr, Nd, Pm, Sm, Eu, Gd, Tb, Dy, Ho, Er, Tm, Yb, or Lu), ITO, ATO, a phthalocynanine compound, a naphthalocyanine compound, an azo dye, an anthraquinone, a squaric acid derivative, an immonium dye, a perylene (such as LUMOGEN™ 083 (commercially available from BASF, NC)), a quaterylene, or a polymethine. The absorber can comprise at least one of a phthalocyanine or a naphthalocyanine, wherein one or both of the foregoing can have a barrier side group, for example, phenyl, phenoxy, alkylphenyl, alkylphenoxy, tert.-butyl, —S-phenyl-aryl, —NH-aryl, NH-alkyl, and the like. The absorber can comprise a Cu(II) phosphate compound, which can comprise one or both of methacryloyloxyethyl phosphate (MOEP) or copper(II) carbonate (CCB). The absorber can comprise a quaterrylenetetracarbonimide compound. The absorber can comprise a hexaboride represented by XB₆, wherein X is at least one of La, Ce, Pr, Nd, Gd, Tb, Dy, Ho, Y, Sm, Eu, Er, Tm, Yb, Lu, Sr, or Ca. The absorber can comprise a hexaboride and a particle comprising at least one of ITO or ATO, wherein the ratio of the hexaboride to the particle can be 0.1:99 to 15:85, and wherein the particle can have an average diameter of less than or equal to 200 nm. The absorber can comprise a combination comprising one or more of the foregoing absorbers. In the emitting region, the absorber can be present in an amount of 0.1 to 20 parts by weight per 100 parts of the emitting layer.

A molar ratio of the luminescent agent to the absorber can be 1:100 to 100:1, or 100:1 to 1:1, or 10:1 to 1:1.

It is noted that when two or more emitting regions are present, the respective emitting regions can comprise the same or different emitting agents.

One or both of the emitted radiation from the luminescent agent or the emitted heat from the absorber can be absorbed by water on a surface of the emitting layer. It is noted that the luminescent agent can also generate heat, to the extent that its quantum yield is less than 1. The emitted radiation (Em) can have a wavelength ranging from that of UV radiation to near IR radiation. The emitted radiation can have a wavelength of 10 nm to 2.5 micrometers. Emissions in the UV and/or near IR wavelength range can be useful in applications such as defogging, defrosting, and deicing as water has absorption coefficients that practically coincide over wavelengths ranging from the UV to near IR, exhibiting respective minima in the visible wavelength range and increasing rapidly away from these minima.

The emitting layer can further comprise a UV absorbing molecule as defined below. The UV absorbing molecule can be present in one or both of the emitting region or the non-emitting region.

The radiation source can be an edge mounted light source as is illustrated in FIG. 1. Alternatively, the radiation source can be remote from the device and coupled to at least one edge of the device by, for example, one or more optical fibers. When a remote radiation source is used, the radiation source can be used in conjunction with one or more devices. The device can comprise one more edge-coupled radiation sources located on one or more edges of the emitting layer. For example, the device can have two edge coupled radiation sources located on opposing edges of the emitting layer or the device can have four edge coupled radiation sources located on two sets of opposing edges of the emitting layer.

The coupling of the radiation source to the device can be optically continuous and can be configured to emit radiation within the escape cone at the edge of the device so that the radiation can be guided through the device by total internal reflection. As used herein, the term “optically continuous” can mean that 90 to 100% of the light from the radiation source is transmitted into the emitting device. The radiation source can be coupled to the edge of the device having a surface as defined by a height, for example, a height d and a width that is not illustrated in the FIG. 1.

The radiation source can be a radiation source that emits 40 to 400 Watts per meter (W/m) as measured along the edge to which the source is coupled. The radiation source can be a radiation source that emits 70 to 300 W/m. The radiation source can be a radiation source that emits 85 to 200 W/m.

The radiation source can emit radiation with a wavelength of 100 to 2,500 nm. The radiation source can emit radiation with a wavelength of 300 to 1,500 nm. The radiation source can emit radiation in the visible range with a wavelength of 380 to 780 nm, or 390 to 700 nm. The radiation source can emit near infrared radiation with a wavelength of 700 to 1,500 nm. The radiation source can emit near infrared radiation with a wavelength of 800 to 1,200 nm. The radiation source can emit UV radiation with a wavelength of 250 to 400 nm. The radiation source can emit UV radiation with a wavelength of 350 to 400 nm. The emitted radiation from the radiation source can be filtered to a desired wavelength before being introduced to the emitting layer.

The radiation source can be, for example, a light-emitting diode (LED), a light bulb (such as a tungsten filament bulb); an ultraviolet light; a fluorescent lamp (such as one that emits white, pink, black, blue, or black light blue (BLB) light); an incandescent lamp; a high intensity discharge lamp (such as a metal halide lamp); a cold-cathode tube, fiber optical waveguides; organic light-emitting diodes (OLED); or a device generating electro-luminescence (EL).

The device can optionally have a mirror located on one or more sides of the device in order to increase the efficiency of the device by reflecting photons that otherwise might exit the device. The mirror can be highly reflective, such as in the near-IR range, and can be a metallization of an edge of the emitting device. Specifically, the device can comprise one or more of an edge mirror, for example, a selectively reflecting edge mirror. The edge mirror can be located on an edge to redirect radiation that would have otherwise escaped from the device back into the emitting layer. The selectively reflecting edge mirror can be located on an edge between the radiation source and the emitting layer, such that the source spectrum is largely transmitted between the radiation source and the device while the emission spectra of a luminescent agent can be largely reflected back into the emitting layer. When emission is desired from only the emitting layer second surface, a surface mirror can be located on the emitting layer first surface or can be located proximal to said surface such that there is a gap located there between. The gap can comprise a liquid (such as at least one of water, oil, a silicon fluid, or the like), a solid that has a lower refractive index than the emitting layer, or a gas (such as at least one of air, oxygen, nitrogen, or the like). The gap can comprise a liquid or gas that has a lower RI than the emitting layer. The gap can be an air gap to support total internal reflection within the device.

The emitting layer can be free of glass and/or any additional layer located on one or both of the first or second surfaces can be free glass. For example, each of the emitting layer and any additional layer can comprise less than 1 wt %, or 0 wt % of glass based on the total weight of the respective layer.

The device can comprise a protective layer on one or both of the first surface or the second surface of the emitting layer. The protective layer can comprise at least one of a UV protective layer, an abrasion resistant layer, or an anti-fog layer. The protective layer can comprise a silicone hardcoat.

A UV protective layer can be applied to an external surface of the device. The UV protective layer can be applied by various means, including dipping the plastic substrate in a coating solution at room temperature and atmospheric pressure (i.e., dip coating). The UV protective layer can also be applied by other methods including, but not limited to, flow coating, curtain coating, or spray coating. For example, the UV protective layer can be a coating having a thickness of less than or equal to 100 micrometers (μm). The UV protective layer can be a coating having a thickness of 4 to 65 micrometers. The UV protective layer can include at least one of a silicone polymer (e.g., a silicone hard coat), a polyurethane (e.g., poly(urethane acrylate)), an acrylics polymer, a polyacrylate (e.g., polymethacrylate, or polymethylmethacrylate), polyvinylidene fluoride, a polyester, or an epoxy. The UV protective layer can comprise a UV blocking polymer, such as at least one of poly(methyl methacrylate) or polyurethane. The UV protective layer can comprise a UV absorbing molecule. The UV protective layer can include a silicone hard coat layer (for example, AS4000, AS4700, or PHC587, commercially available from Momentive Performance Materials).

The UV absorbing molecule can comprise at least one of a hydroxybenzophenone (e.g., 2-hydroxy-4-n-octoxy benzophenone), a hydroxybenzotriazine, a cyanoacrylate, an oxanilide, a benzoxazinone (e.g., 2,2′-(1,4-phenylene)bis(4H-3,1-benzoxazin-4-one, commercially available under the trade name CYASORB UV-3638 from Cytec), an aryl salicylate, or a hydroxybenzotriazole (e.g., 2-(2-hydroxy-5-methylphenyl)benzotriazole, 2-(2-hydroxy-5-tert-octylphenyl)benzotriazole, or 2-(2H-benzotriazol-2-yl)-4-(1,1,3,3-tetramethylbutyl)-phenol, commercially available under the trade name CYASORB 5411 from Cytec). The UV absorbing molecule can comprise at least one of a hydroxyphenylthazine, a hydroxybenzophenone, a hydroxylphenylbenzothazole, a hydroxyphenyltriazine, a polyaroylresorcinol, or a cyanoacrylate. The UV absorbing molecule can be present in an amount of 0.01 to 1 wt %, specifically, 0.1 to 0.5 wt %, and more specifically, 0.15 to 0.4 wt %, based upon the total weight of polymer in the respective region.

The UV protective layer can include a primer layer and a coating (e.g., a top coat). A primer layer can aid in adhesion of the UV protective layer to the device. The primer layer can include, but is not limited to, at least one of an acrylic polymer, a polyester, or an epoxy. The primer layer can also include ultraviolet absorbers in addition to or in place of those in the top coat of the UV protective layer. For example, the primer layer can include an acrylic primer (for example, SHP401 or SHP470, commercially available from Momentive Performance Materials).

An abrasion resistant layer (e.g., a coating or plasma coating) can be applied to one or more surfaces of the device. For example, an abrasion resistant layer can be located on (for example, directly on) one or both of the first surface or the second surface of the device or a second protective layer, such as a UV protective layer, can be located in between. The abrasion resistant layer can include a single layer or a multitude of layers and can add enhanced functionality by improving abrasion resistance of the device. Generally, the abrasion resistant layer can include an organic coating and/or an inorganic coating, for example, comprising at least one of aluminum oxide, barium fluoride, boron nitride, hafnium oxide, lanthanum fluoride, magnesium fluoride, magnesium oxide, scandium oxide, silicon monoxide, silicon dioxide, silicon nitride, silicon oxy-nitride, silicon carbide, silicon oxy carbide, hydrogenated silicon oxy-carbide, tantalum oxide, titanium oxide, tin oxide, indium tin oxide, yttrium oxide, zinc oxide, zinc selenide, zinc sulfide, zirconium oxide, zirconium titanate, or glass.

The abrasion resistant layer can be applied by various deposition techniques such as vacuum assisted deposition processes and atmospheric coating processes. For example, vacuum assisted deposition processes can include, but are not limited to, plasma enhanced chemical vapor deposition (PECVD), arc-PECVD, expanding thermal plasma PECVD, ion assisted plasma deposition, magnetron sputtering, electron beam evaporation, or ion beam sputtering.

Optionally, one or more of the layers (e.g., UV protective layer and/or abrasion resistant layer and/or an anti-fog layer) can be a film applied to an external surface of the device by a method such as lamination or film insert molding. In this case, the functional layer(s) or coating(s) could be applied to the film and/or to the side of the device opposite the side with the film. For example, a co-extruded film, an extrusion coated, a roller-coated, or an extrusion-laminated film comprising greater than one layer can be used as an alternative to a hard coat (e.g., a silicone hard coat) as previously described. The film can contain an additive or copolymer to promote adhesion of the UV protective layer (i.e., the film) to an abrasion resistant layer, and/or can itself include a weatherable material such as an acrylic (e.g., polymethylmethacrylates), a fluoropolymer (e.g., polyvinylidene fluoride, or polyvinyl fluoride), etc., and/or can block transmission of ultraviolet radiation sufficiently to protect the underlying substrate; and/or can be suitable for film insert molding (FIM) (in-mold decoration (IMD)), extrusion, or lamination processing of a three dimensional shaped panel.

One or more of the layers can each independently include an additive. The additive can include at least one of colorant(s) (such as tinting agent(s)), antioxidant(s), surfactant(s), plasticizer(s), infrared radiation absorber(s), antistatic agent(s), antibacterial(s), flow additive(s), dispersant(s), compatibilizer(s), cure catalyst(s), UV absorbing molecule(s) such as at least one of those described above, or adhesion promoter(s) (for example, those disclosed in U.S. Patent Application 2016/0222179). The type and amounts of any additives added to the various layers depends on the desired performance and end use of the device.

The protective layer(s) can be selected such that it does not absorb in the near-IR range.

The protective layer can have a lower refractive index than the emitting layer. The protective layer can have a refractive index that is lower than that of the emitting layer host material.

The emitting layer can be formed by injection molding. For example, the injection molding can comprise injection of a host material composition, for example, from a first nozzle into a mold. After a first amount of time, for example, after 5 to 300 seconds, an emitting agent composition can be simultaneously injected into the mold, for example, from a second nozzle such that the emitting agent composition mixes with the host material composition during the molding to form the emitting region. Once a desired emitting region has been formed, after a second amount of time, the injection of the emitting agent composition can be ceased. Thereafter, the injection from the first nozzle can be ceased. The host material composition can be free of an emitting agent. For example, the host material composition can comprise less than or equal to 0.05 wt %, or 1 to 0.01 wt % of an emitting agent based on a total weight of the host material composition. The emitting agent composition can comprise one or both of a luminescent agent or an absorber. The emitting agent composition can comprise an adhesion promoter. The emitting agent composition can comprise a host material that can be the same or different as the host material in the host material composition. This method of injection molding can result in an emitting layer as illustrated in FIG. 1, where the emitting region spans the distance from the first surface to the second surface. This method can result in a broader concentration gradient, i.e. not a step function as illustrated in FIG. 1, between the emitting region and the non-emitting region.

The emitting layer can be formed by selectively surface infusing the emitting agent and optional an adhesion promoter on a surface of a substrate to form the emitting layer. An emitting composition can be heated to a fluid infusion temperature prior to being contacted with the surface, as heating to the fluid infusion temperature can facilitate infusion of an emitting agent into the host material upon contact. The fluid infusion temperature can be greater than or equal to the melting temperature of the emitting agent. The surface can be heated to a surface infusion temperature prior to the emitting composition being contacted with the surface, as heating to the surface infusion temperature can facilitate infusion of the emitting agent into the host material upon contact. The contacted surface can be heated to an infusion temperature to allow for the infusion of the emitting agent into the host material. The fluid infusion temperature, the surface infusion temperature, and the infusion temperature can each independently be 30 to 100° C., or 90 to 100° C.

The emitting composition can consist essentially of the emitting agent and an optional adhesion promoter. For example, the emitting composition can be free of a solvent that dissolves the host material. The emitting composition can comprise the emitting agent and a liquid. The emitting composition can comprise 5 to 100 wt % of the emitting agent based on the total weight of the emitting composition. The liquid can comprise a solvent that can allow for at least a surface portion of the host material to at least partially dissolve, thereby facilitating infusion of the emitting agent into the host material. The solvent can comprise an organic solvent. The organic solvent can comprise at least one of ethylene glycol butyl ether, diethylene glycol ethylether, diethylene glycol butylether, propylene glycol propylether, dipropylene glycol propylether, tripropylene glycol propylether, or diethylene glycol. The liquid can comprise water.

The selective surface infusing can comprise first masking a surface area of the substrate where the emitting agent is not desired. The masking can comprise putting a contact mask, for example, via an adhesive layer onto a surface of the substrate. The contact mask has the benefit of reducing the ability of the emitting composition from contacting regions where infusion of the agent into the substrate is not desired. An emitting composition can then be contacted with the surface of at least the unmasked area, for example, by at least one of dip coating, flow coating, or spray coating.

The masking can comprise putting a non-contact mask over a surface of the substrate such that the non-contact mask does not come into contact with the surface, thereby reducing the risk of scratching the surface or leaving an adhesive residue. When a non-contact mask is used, the emitting composition can be contacted with the surface of at least the unmasked area by spray coating, for example, by spraying the emitting composition up at the surface of the emitting layer that is oriented horizontal to the ground, thereby reducing run off of the emitting composition into masked regions. An atomizing nozzle can be used to spray the emitting composition onto the surface.

The selective surface infusing can comprise selectively spraying the emitting composition onto the surface in only the emitting area. By selectively spraying the emitting composition, the use of a mask can be avoided.

The selective surface infusing can comprise contacting the emitting composition with a selectively heated surface such that only the area where infusion is desired is heated. For example, the surface can be selectively heated prior to or during contacting with the emitting composition. Conversely, or in addition, the surface can be selectively heated after the contacting to promote infusion only in the heated regions. The surface can be selectively heated, for example, by using local heating elements (such as infrared heaters) located proximal to a second surface such that the heat transmits through the emitting layer to the contacted first surface.

The selective contacting method can be used to contact both the first and second surfaces in one or more contacting steps. When both the first and second surfaces are contacted, the locations of the respective emitting regions can correspond to each other, for example, as illustrated in FIG. 3, or can be located independently from each other.

If the contacting comprises spray coating, the spray coating can comprise spray coating the emitting composition at a temperature of 30 to 100° C., or 90 to 100° C. and at a pressure of 5 to 50 pounds per square inch (psi) (34 to 345 kilopascal), or 15 to 25 psi (103 to 172 kilopascal). The spray coating nozzle can be located 4 to 8 inches (10 to 20 cm) from the surface during the contacting.

The selectively infusing the emitting agent can result in a surface localized emitting region having a concentration gradient of the emitting agent along at least one direction, for example, along the length, L, of the emitting layer. For example, surface localized emitting region 120 can have a higher concentration of an emitting agent near boundary l₁ relative to boundary l₂. The presence of a concentration gradient can be especially helpful for surface localized emitting regions that comprise an absorber as an absorber without a concentration gradient can exhibit exponential decay of heat generation with distance from the radiation source. In these scenarios with a concentration gradient, the concentration of the absorber in surface localized emitting region 120 can be lower near boundary l₂ and higher near boundary l₁, for example when the radiation source is located on an edge of the emitting layer that is closer to l₂ than to l₁. Alternatively, if an additional radiation source was located on the opposing edge of the emitting layer, then the concentration of the absorber near boundary l₂ can be the same as that near boundary l₁ and a concentration in a central location to both boundaries can be higher.

The method of forming a concentration gradient of the emitting agent can comprise contacting the emitting composition with the substrate, wherein the substrate surface has a temperature gradient. In this scenario, the amount of emitting agent that infuses into the substrate will be greater in the regions where the temperature is higher relative to regions where the temperature is lower.

The method of forming a concentration gradient of the emitting agent can comprise varying the contact time of the emitting composition with the substrate. For example, the method can comprise contacting a first region with the emitting composition for an amount of time prior to contacting the emitting composition with a second region. In this scenario, the concentration of the emitting agent in the first region will be greater than the concentration of the emitting agent in the second region.

The method of forming a concentration gradient of the emitting agent can comprise contacting an emitting composition with the substrate, wherein the contacted emitting composition has a varying concentration of the emitting agent with at least direction along the surface, for example, along the length L. In this scenario, the concentration of the emitting agent in the surface localized emitting region will be greater in the region where the concentration of the emitting agent in the emitting composition was greater relative to regions where the concentration of the emitting agent in the emitting composition was less.

After the emitting agent has infused into the surface, the emitting layer can be washed and/or heated and/or air dried, for example, with compressed air to remove any residual emitting composition from the surface.

The emitting layer can be formed via film insert molding. For example, a substrate comprising a host material can be molded onto a film comprising an emitting region and a non-emitting region to form the emitting layer. The emitting region in the film can be formed via one or more of the above-described methods.

The emitting layer can be formed via laminating. For example, a substrate layer comprising a host material can be laminated onto a film comprising an emitting region and a non-emitting region to form the emitting layer. The emitting region in the film can be formed via one or more of the above-described methods.

The device can be a flat panel, a glazing, or a lens for lighting modules. The device can be used for at least one of defogging, defrosting, or deicing, for example in applications such as exterior lighting, for example, automotive exterior lighting (headlights and tail lights), air field lights, street lights, traffic lights, or signal lights; glazings, for example, for transportation (automotive) or construction applications (skylights); appliances, for example, for defrosting a refrigerator door, a freezer door, an interior wall of a freezer or a refrigerator compartment; or for signage. Such a device allows for at least one of defogging, defrosting, or deicing to be accomplished without the use of resistively-heated conductors.

The device can be used for heated surfaces such as mirrors (such as mirrors located in a bathroom, a fitness facility, a pool facility, or a locker room), floors, doors (such as refrigerator doors or freezer doors), shelves, countertops, and the like. When the heated surface is a mirror, the mirror can be “silvered” on a surface of a layer other than the emitting layer.

The device can be a panel (for example, an exterior panel) on a vehicle, for example, a front panel or a rear panel having a sensor disposed on an internal (car side) surface. The device can be a bumper having a sensor. The sensor can be a LIDAR sensor. The sensor can help with autonomous driving of the vehicle. The sensor can detect objects proximal to the vehicle. The sensor can detect the level of ambient light.

Set forth below are non-limiting aspects of the present disclosure.

Aspect 1: An emitting device comprising: a radiation source that emits a source radiation coupled to an edge of an emitting layer; wherein the emitting layer comprises an emitting region comprising a host material and an emitting agent and a non-emitting region comprising the host material and that is free of the emitting agent; wherein the emitting agent comprises at least one of a luminescent agent or an absorber; wherein the emitting layer has a first surface and a second surface; wherein the edge has a height of d and the first surface has a length L, wherein length L is greater than height d, and the ratio of the length L to the height d is greater than or equal to 10; wherein, during use, the source radiation is transmitted from the radiation source through the edge and excites the emitting agent such that, if the luminescent agent is present, the luminescent agent emits an emitted radiation, wherein at least a portion of the emitted radiation exits through the first surface through an escape cone; and, if the absorber is present, the absorber emits heat.

Aspect 2: The device of Aspect 1, wherein one or both of the emitting layer comprises the luminescent agent; wherein the luminescent agent optionally has a longest average dimension of less than or equal to 40 nm; or the host material comprises at least one of polycarbonate, polypropylene, polyester, polyacrylate, polyvinyl butyral, polyisoprene, or a polyimide.

Aspect 3: The device of any of the preceding aspects, wherein the emitting layer comprises the luminescent agent and the absorber; wherein an absorption spectrum of the absorber overlaps with the emission spectrum of the luminescent agent.

Aspect 4: The device of any of the preceding aspects, wherein the emitting region has a gradient concentration of the emitting agent along the length L.

Aspect 5: A method of forming an emitting layer, for example, the emitting layer of the device of any one of the preceding aspects, comprising: injection molding a host material composition comprising the host material into a mold to form the non-emitting region; after a first amount of time, injection molding an emitting agent composition while simultaneously injection molding the host material composition into the mold for a second amount of time to form the emitting region; and after the second amount of time, ceasing the injection molding of the host material composition.

Aspect 6: A method of forming an emitting layer, for example, the emitting layer of the device of any one or more of Aspects 1 to 4, comprising selectively infusing the emitting agent into a surface of a substrate comprising the host material to form the emitting region that is localized to the first surface.

Aspect 7: The method of Aspect 6, wherein the selectively infusing the emitting agent comprises masking the first surface with a mask; contacting an unmasked region of the first surface with an emitting composition comprising the emitting agent to form a contacted surface; and heating at least one of the substrates prior to the contacting, the emitting composition prior to the contacting, or the contacted surface, such that the emitting agent infuses into the substrate in the unmasked region to form the emitting region.

Aspect 8: The method of Aspect 7, wherein the mask comprises a contact mask that is in direct contact with the surface of the substrate; wherein the masking comprises masking with the contact mask and wherein the contacting the unmasked region comprises at least one of dip coating, flow coating, or spray coating.

Aspect 9: The method of Aspect 7, wherein the mask comprises a non-contact mask that is not in direct contact with the surface of the substrate; wherein the masking comprises masking with the non-contact mask; and wherein the contacting the unmasked region comprises spray coating.

Aspect 10: The method of Aspect 6, wherein the selectively infusing the emitting agent into the first surface comprises, selectively contacting a desired region of the first surface with an emitting composition, in the absence of a mask, to form a contacted surface; and heating at least one of the substrates prior to the contacting, the emitting composition prior to the contacting, or the contacted surface, such that the emitting agent infuses into the substrate in the desired region to form the emitting region.

Aspect 11: The method of Aspect 6, wherein the selectively infusing the emitting agent into the first surface comprises, contacting the emitting composition with the first surface and selectively heating a desired emitting region such that the emitting agent infuses into the substrate in the desired emitting region to form the emitting region; wherein the selectively heating occurs before, during, or after the contacting.

Aspect 12: The method of any one or more of Aspects 6 to 11, wherein the selectively infusing the emitting agent into the first surface comprises forming a concentration gradient of the emitting agent in the emitting region.

Aspect 13: The method of Aspect 12, wherein the forming the concentration gradient comprises at least one of: forming a temperature gradient in the substrate and contacting the substrate with the emitting composition; varying a contact time in different locations of the substrate with emitting composition; or varying a concentration of the emitting agent in the emitting composition with contact location.

Aspect 14: The method of any one or more of Aspects 6 to 13, further comprising selectively contacting the same or different emitting composition onto the second surface.

Aspect 15: A method of forming an emitting layer, for example, the emitting layer of the device of any one or more of Aspects 1 to 4, comprising film insert molding a substrate onto a film comprising an emitting region and a non-emitting region; or laminating the film onto a substrate.

Aspect 16: The method of any one or more of Aspects 6 to 15, wherein the emitting composition comprises an adhesion promoter.

Aspect 17: Use of an emitting layer of any one or more of the preceding aspects to reduce the amount of water on the first surface.

Aspect 18: A method of reducing an amount of water from an emitting region on a surface of an emitting layer in a device, for example, of any one or more of the preceding aspects including emitting radiation from a radiation source coupled to an edge of an emitting layer; wherein the emitting layer comprises an emitting region comprising a host material and an emitting agent and a non-emitting region comprising the host material and that is free of the emitting agent; wherein the emitting agent comprises at least one of a luminescent agent or an absorber; wherein the emitting layer has a first surface and a second surface; wherein the edge has a height of d and the first surface has a length L, wherein length L is greater than height d, and the ratio of the length L to the height d is greater than or equal to 10; wherein, during the emitting, the source radiation is transmitted from the radiation source through the edge and excites the emitting agent such that, if the luminescent agent is present, the luminescent agent emits an emitted radiation, wherein at least a portion of the emitted radiation exits through the first surface through an escape cone; and, if the absorber is present, the absorber emits heat.

Aspect 19: The emitting device of any one or more of the preceding aspects, wherein the device is a glazing, a lens, a mirror, an exterior panel, a bumper, or a headlamp.

Aspect 20: The emitting device of any one or more of the preceding aspects, wherein the emitting agent is present in a surface localized emitting region that does not span the height d of the emitting layer;

Aspect 21: The emitting device of any one or more of the preceding aspects, wherein the emitting layer has a visible light transmittance of greater than or equal to 70%, or 1 to 75%, or 5 to 30%, or 60 to 75% determined using 3.2 mm thick samples using ASTM D1003-11, Procedure B using CIE standard illuminant C, with unidirectional viewing.

Aspect 22: The emitting device of any one or more of the preceding aspects, wherein the device is free of glass or is free of a glass layer located on the first surface or the second surface.

Aspect 23: The emitting device of any one or more of the preceding aspects, wherein at least one of a thickness of the surface localized emitting region is 10 to 1,000 micrometers, or 50 to 500 micrometers, or 100 to 200 micrometers; or the thickness of the surface localized emitting region spans less than or equal to 90%, or 0.1 to 50%, or 0.1 to 10% of the height of the emitting layer.

Aspect 24: The emitting device of any one or more of the preceding aspects, wherein the luminescent agent is present and at least a portion of the emitted radiation exits through the first surface and the second surface through the escape cone. The luminescent agent can be proximal to only the first surface, or can be proximal to both the first surface and the second surface.

The compositions, methods, and articles can alternatively comprise, consist of, or consist essentially of, any appropriate materials, steps, or components herein disclosed. The compositions, methods, and articles can additionally, or alternatively, be formulated so as to be devoid, or substantially free, of any materials (or species), steps, or components, that are otherwise not necessary to the achievement of the function or objectives of the compositions, methods, and articles.

The terms “a” and “an” do not denote a limitation of quantity, but rather denote the presence of at least one of the referenced item. The term “or” means “and/or” unless clearly indicated otherwise by context. Reference throughout the specification to “an embodiment,” “another embodiment,” “some embodiments,” “an aspect,” and so forth, means that a particular element (e.g., feature, structure, step, or characteristic) described in connection with the embodiment is included in at least one embodiment described herein, and may or may not be present in other embodiments. In addition, it is to be understood that the described elements may be combined in any suitable manner in the various embodiments.

When an element such as a layer, film, region, or substrate is referred to as being “on” another element, it can be directly on the other element or intervening elements may also be present. In contrast, when an element is referred to as being “directly on” another element, there are no intervening elements present.

“Optional” or “optionally” means that the subsequently described event or circumstance may or may not occur, and that the description includes instances where the event occurs and instances where it does not.

Unless specified to the contrary herein, all test standards are the most recent standard in effect as of the filing date of this application, or, if priority is claimed, the filing date of the earliest priority application in which the test standard appears.

The endpoints of all ranges directed to the same component or property are inclusive of the endpoints, are independently combinable, and include all intermediate points and ranges. For example, ranges of “up to 25 wt %, or 5 to 20 wt %” is inclusive of the endpoints and all intermediate values of the ranges of “5 to 25 wt %,” such as 10 to 23 wt %, etc.

The suffix “(s)” as used herein is intended to include both the singular and the plural of the term that it modifies, thereby including one or more of that term (e.g., the colorant(s) includes one or more colorants). The terms “first,” “second,” and the like as used herein do not denote any order, quantity, or importance, but rather are used to distinguish one element from another. The term “at least one of” means that the list is inclusive of each element individually, as well as combinations of two or more elements of the list, and combinations of at least one element of the list with like elements not named. The term “combination” is inclusive of blends, mixtures, alloys, reaction products, and the like.

Unless defined otherwise, technical and scientific terms used herein have the same meaning as is commonly understood by one of skill in the art to which this disclosure belongs. Compounds are described using standard nomenclature. For example, any position not substituted by any indicated group is understood to have its valency filled by a bond as indicated, or a hydrogen atom. A dash (“-”) that is not between two letters or symbols is used to indicate a point of attachment for a substituent. For example, —CHO is attached through carbon of the carbonyl group.

All cited patents, patent applications, and other references are incorporated herein by reference in their entirety. However, if a term in the present application contradicts or conflicts with a term in the incorporated reference, the term from the present application takes precedence over the conflicting term from the incorporated reference.

While particular embodiments have been described, alternatives, modifications, variations, improvements, and substantial equivalents that are or may be presently unforeseen may arise to applicants or others skilled in the art. Accordingly, the appended claims as filed and as they may be amended are intended to embrace all such alternatives, modifications variations, improvements, and substantial equivalents.

1. An emitting device comprising:
a radiation source that emits a source radiation coupled to an edge of an emitting layer;
wherein the emitting layer comprises an emitting region comprising a host material and an emitting agent and a non-emitting region comprising the host material and that is free of the emitting agent;
wherein the emitting agent comprises at least one of a luminescent agent or an absorber; wherein the host material comprises a polymer;
wherein the emitting layer has a first surface and a second surface; wherein the edge has a height of d and the first surface has a length L, wherein length L is greater than height d, and the ratio of the length L to the height d is greater than or equal to 10; wherein the emitting agent is present in a surface localized emitting region that does not span the height d of the emitting layer;
wherein, during use, the source radiation is transmitted from the radiation source through the edge and excites the emitting agent such that, if the luminescent agent is present, the luminescent agent emits an emitted radiation, wherein at least a portion of the emitted radiation exits through the first surface through an escape cone; and, if the absorber is present, the absorber emits heat.

2. The device of claim 1, wherein one or both of
the emitting layer comprises the luminescent agent; and wherein the luminescent agent optionally has a longest average dimension of less than or equal to 40 nm; or
the host material comprises at least one of polycarbonate, polypropylene, polyester, polyacrylate, polyvinyl butyral, polyisoprene, or a polyimide.

3. The device of claim 1, wherein the emitting layer comprises the luminescent agent and the absorber; wherein an absorption spectrum of the absorber overlaps with the emission spectrum of the luminescent agent.

4. The device of claim 1, wherein the emitting region has a gradient concentration of the emitting agent along the length L.

5. The device of claim 1, wherein the emitting layer has a visible light transmittance of greater than or equal to 70% determined using 3.2 mm thick samples using ASTM D1003-11, Procedure B using CIE standard illuminant C, with unidirectional viewing.

6. The device of claim 1, wherein the device is free of glass or is free of a glass layer located on the first surface or the second surface.

7. The device of claim 1, wherein at least one of a thickness of the surface localized emitting region is 10 to 1,000 micrometers; or the thickness of the surface localized emitting region spans less than or equal to 90%, of the height of the emitting layer.

8. The device of claim 1, wherein the luminescent agent is present and at least a portion of the emitted radiation exits through the first surface and the second surface through the escape cone.

9. A method of forming the emitting layer of the device of claim 1, comprising selectively infusing the emitting agent and an optional adhesion promoter into a surface of a substrate comprising the host material to form the emitting region that is localized to the first surface.

10. The method of claim 9, wherein the selectively infusing the emitting agent comprises masking the first surface with a mask;
contacting an unmasked region of the first surface with an emitting composition comprising the emitting agent to form a contacted surface; and
heating at least one of the substrate prior to the contacting, the emitting composition prior to the contacting, or the contacted surface, such that the emitting agent infuses into the substrate in the unmasked region to form the emitting region.

11. The method of claim 10, wherein the mask comprises a contact mask that is in direct contact with the surface of the substrate; wherein the masking comprises masking with the contact mask and wherein the contacting the unmasked region comprises at least one of dip coating, flow coating, or spray coating.

12. The method of claim 10, wherein the mask comprises a non-contact mask that is not in direct contact with the surface of the substrate; wherein the masking comprises masking with the non-contact mask; and wherein the contacting the unmasked region comprises spray coating.

13. The method of claim 9, wherein the selectively infusing the emitting agent into the first surface comprises selectively contacting a desired region of the first surface with an emitting composition, in the absence of a mask, to form a contacted surface; and
heating at least one of the substrate prior to the contacting, the emitting composition prior to the contacting, or the contacted surface, such that the emitting agent infuses into the substrate in the desired region to form the emitting region.

14. The method of claim 9, wherein the selectively infusing the emitting agent into the first surface comprises contacting the emitting composition with the first surface and selectively heating a desired emitting region such that the emitting agent infuses into the substrate in the desired emitting region to form the emitting region;
wherein the selectively heating occurs before, during, or after the contacting.

15. The method of claim 9, wherein the selectively infusing the emitting agent into the first surface comprises forming a concentration gradient of the emitting agent in the emitting region.

16. The method of claim 15, wherein the forming the concentration gradient comprises at least one of:
forming a temperature gradient in the substrate and contacting the substrate with the emitting composition;
varying a contact time in different locations of the substrate with the emitting composition; or
varying a concentration of the emitting agent in the emitting composition with contact location.

17. A method of forming the emitting layer of the device of claim 1, comprising film insert molding a substrate onto a film comprising an emitting region and a non-emitting region; or laminating the film onto a substrate.

18. A method of reducing an amount of water on a first surface of the emitting layer of claim 1 comprising:
emitting the source radiation from the radiation source thereby exciting the emitting agent causing it to emit the emitted radiation or the heat; wherein the emitted radiation or the heat results in the reducing of the amount of water.
